(19) United States
(12) Patent Application Publication
(10) Pub. No.: US 2010/0185432 A1
(43) Pub. Date: Jul. 22, 2010

(54) Headset Wireless Noise Reduced Device for Language Translation

(75) Inventor: Irving Almagro, Irvine, CA (US)

Correspondence Address: Irving Almagro, 2906 Simplicity, Irvine, CA, 92620, US

(73) Assignee: VOICE MUFFLER CORPORATION, Irvine, CA (US)

(21) Appl. No.: 12/692,586

(22) Filed: Jan. 22, 2010

Related U.S. Application Data
(60) Provisional application No. 61/146,346, filed on Jan. 22, 2009.

(51) Int. Cl. G06F 17/28

(52) U.S. Cl. 704/2

(57) ABSTRACT

A wireless hands-free language translation device in accordance to a headset configuration which when used swivels said device inwards to cover the mouth area of a user wherein such arrangement prevents the person spoken to from hearing most of the user's voice. Said device comprises a microphone to capture speech, a transceiver to transmit and receive signals, and a loudspeaker to deliver a received translated speech to a person other than said user.

### RELATED APPLICATION

This application claims priority date under 35 U.S.C. sctn. 119(e) from the following U.S. provisional application: Application Ser. No. 61/146,346, titled “Headset Wireless Voice Muffled Device for Language Translation,” filed on Jan. 22, 2009.

### BACKGROUND OF THE INVENTION

The present invention relates generally to interlingual communications, passive sound muffling of the user's voice, headsets, and more particularly to handsfree realtime speech-to-speech translation devices which are essential for anyone who wishes to communicate with someone who speaks a different language.

The reporting device or Stenomask that was patented over 20 years ago in U.S. Pat. No. Gore, 4,129,754 provided a viable solution in reducing undesirable sounds or noise when using a microphone in ruckus adverse environments such as courtrooms. The voice muffled device has been found to be an excellent apparatus for speech recognition systems due to: 1) its microphone is positioned at a constant distance from the speaker's mouth which is essential in achieving a high rate of recognition success, and 2) it stopped outside noise from being captured by the microphone thereby reducing signal distortion. However, since the effectiveness of the device necessitated that it be pressed firmly against a user's face, such effortful task would be seriously lacking in convenience and therefore undesireable. As a minimum consideration for attaining an effective interlingual communication, a device that can block an adequate amount of a speaker's unwanted voice would greatly improve the intelligibility of a translated speech. A voice muffling contraption that is less cumbersome is one of the features that the present invention seeks to achieve. By muffling the user's speech, a more intelligible conversation with a foreigner will be accomplished since there will be less of the user's speech that can jumble with the translated speech. An active noise canceling capability of the invention would be the ultimate method of reducing unwanted vocal noise.

There are currently numerous PDA-style handheld devices which translate languages such as the iTravl by Ectaco. Unfortunately, these devices are limited to small sets of vocabularies due to the fact that they rely on internal memory chips for storage. Increasing the memory capacity to accomodate larger vocabularies would involve making these handheld devices bigger physically, thereby increasing their size, weight and power requirement. A better approach is to use a handsfree solution whereby the vocabularies can be stored in a remote file server, then use an integrated transceiver to send a speech to be translated and retrieve the translated speech.

Bluetooth wireless technology is a short-range communications technology intended to replace the cables connecting portable and/or fixed devices while maintaining high levels of security. WiMAX, LTE and similar broadband technology provide long range telecommunications for portable devices. WiFi and Wireless USB technology facilitate the telecommunications of voice and data signals to computer systems. UHF, VHF, Microwave and other radio frequency transceiver technologies convert and reproduce audio and digital signals into radio waves to facilitate telecommunications.

Thus, embedding a microphone inside a sound muffler, have the user's speech converted to a desired language and then feed the translated speech to a loudspeaker for a foreigner to hear; and still further, fix an external microphone on said device, capture a foreigner's speech, convert said speech to the user's language and output it to an earphone for the user to hear—such arrangements would manifestly provide a headset user a convenient, quieter, and effective interlingual communications device.

### OBJECTS OF THE INVENTION

It is therefore an object of the invention to provide a headset device that can dampen unwanted vocal sounds from a user speaking a certain language; capture the user's speech by means of a microphone; translate said speech into a language intended for a foreigner utilizing an integrated speech processing system or a remote translation facility connected wirelessly by an integrated transceiver; and convert the translated speech into an audible sound outputted by the external loudspeaker that can be heard by the intended foreigner. Further, it is an object of the invention to allow the speech of the foreigner to be captured by the microphone located on the external part of the device; translate said speech into a user's language utilizing an integrated speech processing system or a remote translation facility linked by means an integrated transceiver; and output the translated speech to the device's earphone to be heard by the user.

A further object of the invention is to provide a handsfree voice muffled translation device on a headband that can include or complement an existing video camera and/or a display system, such as those already implemented on some military helmets, to improve the translation effectiveness.

A further object of the invention is to provide a handsfree voice muffled translation device for a headset that can effectively eliminate unwanted sounds by incorporating a removable sound absorbing interior housing or baffle component.

A further object of the invention is to provide a handsfree voice muffled translation device for a headset that can utilize a user's voice to adjust the volume of the loudspeaker output.

A further object of the invention is to provide a handsfree voice muffled translation device for a headset that can utilize active noise canceling system to muffle a user's voice.

A further object of the invention is to provide a handsfree voice muffled translation device for a headset that will automatically adjust the volume of the loudspeaker output depending on the audio intensity of the user's voice.

### SUMMARY OF THE INVENTION

In an exemplary embodiment, the present invention comprises: a headband assembly; a mouthpiece assembly with noise reducing components defining a concave-shaped housing that contours about a user's mouth area and swivels sideways, further comprising an internal microphone to capture the user's speech, an external microphone to capture a foreigner's speech, and an external loudspeaker for outputting the translated speech to be heard by a foreigner; and a language translation system further comprising a standalone language translation system to translate speech automatically or a transceiver system that can link to a remote translation facility for transmitting untranslated speech and receiving translated speech, and an earphone to allow the user to hear a foreigner's translated speech.

In another exemplary embodiment, the present invention comprises: a headband assembly; a detachable mouthpiece assembly with noise reducing components defining a concave-shaped housing that contours about a user's mouth area and swivels up or down, further comprising an internal microphone to capture the user's speech, an external microphone to capture a foreigner's speech, and an external loudspeaker for outputting the translated speech to be heard by a foreigner; and a language translation system further comprising an integrated language translation system to translate speech automatically or a transceiver system that can link to a remote translation facility for transmitting untranslated speech and receiving translated speech, and a compatible wireless earphone to allow a user to hear a foreigner's translated speech.

In another exemplary embodiment, the present invention comprises: a headband assembly; a detachable mouthpiece assembly with noise reducing components defining a concave-shaped housing that contours about a user's mouth area and swivels up or down, further comprising an internal microphone to capture the user's speech, an external microphone to capture a foreigner's speech, an external loudspeaker for outputting the translated speech to be heard by a foreigner, and a video camera component to capture a foreigner's gestures; and a language translation assembly further comprising a standalone language translation system to translate speech automatically or a transceiver system that can link to a remote translation facility for transmitting untranslated speech and receiving translated speech, and an earphone to allow the user to hear a foreigner's translated speech.

### BRIEF DESCRIPTION OF THE DRAWINGS

FIG. 1 is a perspective view of an embodiment of the invention showing the major components comprising a headband assembly with a hinge mechanism, a mouthpiece assembly, and a language translation assembly.

FIG. 2 is a perspective view of an embodiment of the invention showing the major components comprising a headband assembly with a flexible hollow boom, a mouthpiece assembly, and a language translation assembly.

FIG. 3 is a perspective view of a headband assembly of an embodiment of the invention with a hinge mechanism.

FIG. 4 is a perspective view of a headband assembly of an embodiment of the invention with a flexible hollow boom.

FIG. 5 is a front elevational view, seen from a user's perspective, of a mouthpiece assembly of an embodiment of the invention.

FIG. 6 is a front elevational view, seen from a user's perspective, of a mouthpiece assembly of an embodiment of the invention showing the major internal components after the protective cover has been removed.

FIG. 7 is a top plan view of a mouthpiece assembly of an embodiment of the invention.

FIG. 8 is a rear elevational view, seen from a user's perspective, of a mouthpiece assembly of an embodiment of the invention.

FIG. 9 is a front elevational view, seen from a user's perspective, of a mouthpiece assembly of an active noise canceling embodiment of the invention.

FIG. 10 is a front elevational view, seen from a user's perspective, of a mouthpiece assembly showing the major internal components of an active noise canceling adaptation after the protective material or cover has been removed.

FIG. 11 is a perspective view of an embodiment of the invention showing a language translation assembly for a headband assembly utilizing a hinge mechanism.

FIG. 12 is a perspective view of an embodiment of the invention showing a language translation assembly for a headband assembly utilizing a flexible hollow boom.

FIG. 13 is a side view of an earpiece component for a headband assembly utilizing a flexible hollow boom of an embodiment of the invention.

FIG. 14 is a right side view of a user showing the invention being closed or in the in-use arrangement.

FIG. 15 is a left side view of a user showing the invention being closed or in the in-use arrangement.

FIG. 16 is a right side view of a user showing the invention being open or in the not-in-use arrangement.

FIG. 17 is a left side view of a user showing the invention being open or in the not-in-use arrangement.

FIG. 18 is a perspective view of a user shown with the invention being closed or in the in-use arrangement.

FIG. 19 is a perspective view of a user shown with the invention being open or in the not-in-use arrangement.

FIG. 20 is a perspective view of a user shown with the invention placed in an over-the-head storage arrangement.

FIG. 21 is pictorial representation showing a user having his speech translated for a foreigner in accordance with an embodiment of the invention.

FIG. 22 is pictorial representation showing a foreigner speaking to a user in accordance with an embodiment of the invention.

FIG. 23 is pictorial representation showing a user speaking to a fellow native speaker in accordance with an embodiment of the invention.

FIG. 24 is a flowchart diagram summarizing a speech-to-speech language translation process using a standalone language translation system in accordance with an embodiment of the invention.

FIG. 25 is a flowchart diagram summarizing a speech-to-speech language translation process using an integrated wireless transceiver in accordance with an embodiment of the invention.

FIG. 26 is a diagram of a typical operational mode of the device in accordance with an embodiment of the invention showing the invention's short range communication links.

FIG. 27 is a diagram of a typical operational mode of the device in accordance with an embodiment of the invention showing the invention's short and long range communication links.

### DETAILED DESCRIPTION OF THE PREFERRED EMBODIMENT

As used herein, the term “user,” or “first person,” is intended but not limited, to generally refer to a person who is operating or manipulating or holding or grasping, or speaking to, or a combination thereof, a microphonic device having a purpose of effecting a translation of his or her speech to an intended language. Generally, said user is wearing a military style combat helmet with chinstraps in place speaking his native language into the microphonic device.

As used herein, the term “foreigner,” or “second person,” is intended but not limited, to generally refer to someone who speaks a language that is different from a user's native language. A foreigner can also be a person who is not operating nor manipulating nor holding nor grasping, nor a combination thereof, but may speak in his native or foreign language to a user's device.

As used herein, the term “housing” is intended but not limited, to generally refer to a metallic or non-metallic or a combination of both, protective cover, casing, case, shell or enclosure designed to contain, enclose or support another housing, mechanical, electrical, electronic components, and/or any combination thereof. It can be homogeneous, heterogeneous, multi-layered, multi-bodied, multi-frame, multi-colored and/or any combination thereof. It may be rigid, semi-rigid, flexible, supple, and/or a combination thereof. It may also have properties such as sound absorbing, soundproofing, sound muffling, noise reducing, sound blocking, sound baffling, sound distorting, anti-bacterial, germicidal, anti-viral, anti-odor, electromagnetic shielding, radiation shielding, and/or a combination thereof.

As used herein, the term “language translation system,” or “language processing unit,” or “language translation unit,” or “personal translator,” is intended but not limited, to generally refer to a standalone computer system having electronic and electrical components such as a voice recognition circuit, text-to-speech converter, CODEC, DAC, Advanced RISC Machine (ARM) chip, analog and/or digital computer, speech application processor, memory, firmware, sound quality optimizer, input/output interface circuitry, power supply, battery, battery charging circuit, timer, test circuitry, amplifier, video circuit, digital and analog processors, signal conditioners, analog and digital amplifiers, automatic volume or gain control circuitry, anti-noise signal generating circuits, other associated mechanical, electronic and electrical components, and/or a combination thereof, the main function of which is: to effect a speech-to-speech language translation; to condition and/or amplify translated speech; and to output translated speech signals at optimal levels. Further, software programs such as language translation software, voice-recognition software, text-to-speech software, voice-enabling software, voice-control software, and/or a combination thereof, can be part of the language translation system. An active noise canceling circuitry can also be incorporated into the language translator. It should be further understood that it is a common practice in the electronics industry to use expansion slots, adapters, sockets, connectors, and/or any combination thereof, with the goal of providing robustness, enhancement capability, expansion capability, and natural progressive extensibilty of the language processor. Examples of such products include Solid State Drives (SSD), flash drives, firmware ROMs, USB drives, and peripherals. An example of the technology's normal progression is the PC's modem whereby they have now been integrated into the PCs CPU instead of being an external device with its own power supply. As well, some components of the transceiver do not necessarily have to stay enclosed within the module for it to qualify as a transceiver. For example, to lengthen the language translator's usage, a battery pack can be added, and to extend its vocabularies, more memory or a hard drive or solid state drive can be added, externally. Other examples include SIM cards, SD memory cards, CF memory cards, amplifiers, firmware ROMs, etc. Further, due to the rapid advances in the semiconductor industry with regards to modularization, it is further understood that more and more discrete components are being integrated and miniaturized therein. For example, most PC practitioners refer to the CPU as just the computer chip, and related supporting circuits such as a digital communications controllers I/O controller, firmware ROM, timing circuits, cache controller, were considered separate or discrete components. Nowadays, the CPU is composed of all these formerly discrete components that have been integrated or modularized into a single chip or module. It is therefore understood that the terms mentioned above also encompass all advancements related to the computer processing technology such as miniaturization, integration and modularization of discrete components.

As used herein, the term “transceiver,” or “personal transceiver,” or “transceiver system,” or “transceiver unit,” or “transceiver module,” is intended but not limited, to generally refer to a full-duplex, wireless or radio frequency system having electronic components and circuitry such as a transmitter, receiver, CODEC, DAC, Advanced RISC Machine (ARM) CPU, application processor, memory, sound quality optimizer, telephone number dialing circuitry, antenna, power supply, battery, battery charger, timer, test circuitry, amplifier, video circuit, digital and analog processors, AF or RF signal conditioners, automatic volume or gain control circuitry, active noise cancelation electronics, other associated mechanical, electronic and electrical components, and/or any combination thereof, the main function of which is: to effect a speech-to-speech language translation; to transmit analog and/or digital signals; and to receive analog and/or digital signals. The transmission and reception mode of a personal translator can also be a simplex, duplex or multiplex. Further, software programs such as voice recognition, speech-to-text, text-to-speech, active noise cancelation, and/or a combination thereof, may be incorporated into the transceiver for an enhanced capability of the invention such as the use of automated machine translation. An image or video processor may also be integrated into the transceiver to allow a remotely located interpreter get a better grasp of the user's surrounding, thereby effecting a more accurate translation. It should be further understood that it is a common practice in the electronics industry to use expansion slots, adapters, sockets, connectors, and/or any combination thereof, with the goal of providing robustness and extensibilty of the transceiver by adding enhancement capabilities and new functionalities of their hardware products. An example of this is the PC's modem whereby they have now been integrated into the PCs CPU instead of being an external device with its own power supply. As well, some components of the transceiver do not necessarily have to stay enclosed within the module for it to qualify as a transceiver. For example, to lengthen the transceiver's usage, a battery pack can be added, and to extend its range a RF amplifier and longer antenna can be added, externally. Other examples include SIM cards, SD memory cards, CF memory cards, amplifiers, firmware ROMs, etc. These additional components are associated with the transmitting and receiving functions and are therefore considered integral parts of the “transceiver” and thus may not need to be specified as separate components. Further, due to the rapid advances in the semiconductor industry with regards to miniaturization, it is further understood that more and more discrete components are being integrated and made modular therein. For example, most PC practitioners refer to the CPU as just the computer chip, and related supporting circuits such as a digital communications controllers I/O controller, firmware ROM, timing circuits, cache controller, were considered separate or discrete components. Nowadays, the CPU is composed of all these formerly discrete components that have been integrated or modularized into a single chip or module. Similarly, the transceiver has been constantly transitioned into a modularized structure and therefore understood that the term also encompasses, but not limited, to the integration and modularization of discrete components that relate to the function of transmitting and/or receiving analog/digital signals. Some wireless base stations are also considered as transceivers since their main function is to transmit and receive data in addition to signal processing and conditioning.

As used herein, the term “multifunction key,” or “multi-key” is intended but not limited, to generally refer to a push button switch which allows the invention to be activated, powered up or powered down, pair with compatible wireless devices, run a self-test or bootup routine, as well as other tasks associated with the efficient functioning and high performance of the transceiver system. The transceiver multi-key starts up and maintains the process of getting power to the transceiver from the power source, typically a battery, or starting a standby timer which powers down the transceiver after a set period of time, a function also known as auto-shutoff used for conserving the device's battery. This key can also be used to power down the device when the user depresses it for a few seconds. Additionally, this key may also be associated or integrated with small indicator lamps which provide status information of the wireless device. It is understood that new functions are continually added to this component to enhance the transceiver's capabilities, so implementing these enhancements on the current invention would be embraced and considered as a normal progression or transition of its technology. A power switch used for powering up, powering down, timed shutdown, or placing a personal translator on a standby mode, may also be called a multi-key.

As used herein, the term “microphone” is intended but not limited, to generally refer to a device or an instrument that converts sound waves into an electric current, usually fed into a sound processor, an amplifier, a recorder, or a broadcast transmitter. It can also be an instrument used to capture audio waves from a user of an electronic device such as a wireless language translator, a cellphone, a mobile phone, a wireless headset and other speech input devices. A microphone can also be any type depending upon the manufacturer's or the user's preference—whether it be sound quality, noise canceling capability, weight and/or cost consideration, size, ruggedness, and/or a combination thereof. It is understood that the microphone technology is constantly evolving and improving which therefore makes it very conceivable that the microphone used in the present invention may adopt all the aforementioned enhancements and/or improvements thereof.

As used herein, the term “liner,” is intended but not limited, to generally refer to a piece of thin substance that can have properties such as germicidal, anti-bacterial, antibiotic, anti-microbial, anti-odor, sound absorbing, soundproofing, windscreen, adhesive agent and/or any combination thereof.

As used herein, the term “earpiece,” or “earphone,” or “headphone,” is intended but not limited, to generally refer to a device or an instrument that converts electrical signals into audible waves or sounds, of a size that is generally small or adjustable, lightweight, corded or cordless, with or without a hook, and/or a combination thereof, which allows a typical person to wear said device on his head. It can have features such as high sound quality, automatic volume control, enhanced equalizer, noise canceling capability, ultra lightweight, interchangeable or replaceable cushion cover, wireless, cordless, miniaturized, rugged, and/or a combination thereof. It is understood that the earphone technology is constantly evolving and improving which therefore makes it very understandable that the earphone used in the present invention may be adapted or replaced by advanced or improved models thereof.

As used herein, the term “battery”, or “battery pack”, is intended but not limited, to generally refer to a direct-current voltage source made up of one or more units that convert chemical, thermal, nuclear, mechanical or solar energy into electrical energy. It can be disposable, rechargeable type and/or a combination thereof. It is understood that the battery technology is constantly evolving and improving, therefore the type or kind of battery that the present invention may adopt will depend on the preference of an application or manufacturer.

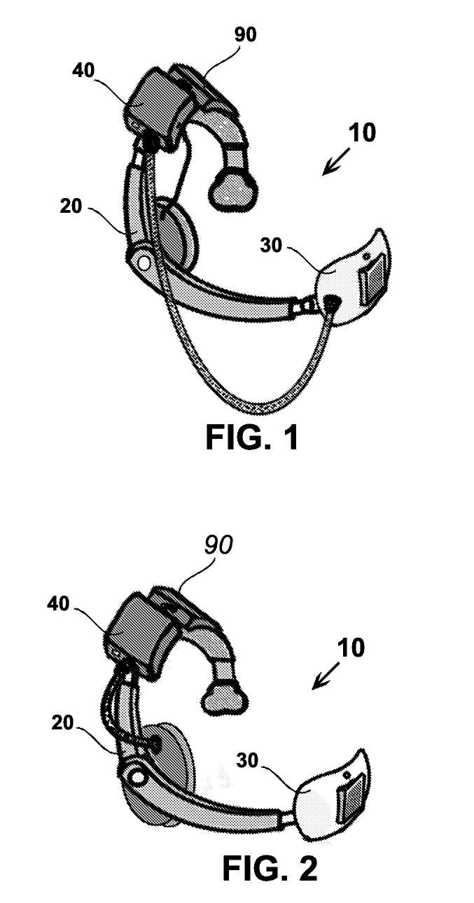

FIG. 1 shows the present invention, seen as general reference 10, comprising of three main assemblies, namely: a headband assembly 20 further comprising a generally rigid boom 22a or a flexible boom 22b, illustrated in FIG. 2; a mouthpiece assembly 30; and a language translation assembly 40 which can be a standalone personal translator 40a or a personal transceiver 40b. A personal translator 40a is generally a preferred embodiment in situations whereby there is no wireless connectivity to a remote translation facility or it is desired to utilize only a localized version of a language translating system. On the other hand, a personal transceiver 40b can be a preferred choice over a personal translator due to its lighter weight, robustness, and smaller drain on the battery. The translation assembly 40 should preferably be mounted on the top portion of headband 20. Alternatively, a battery pack 90 that is easily rechargeable, detachable, and/or replaceable can be implemented for the invention 10 and mounted in proximity with the translation assembly 40.

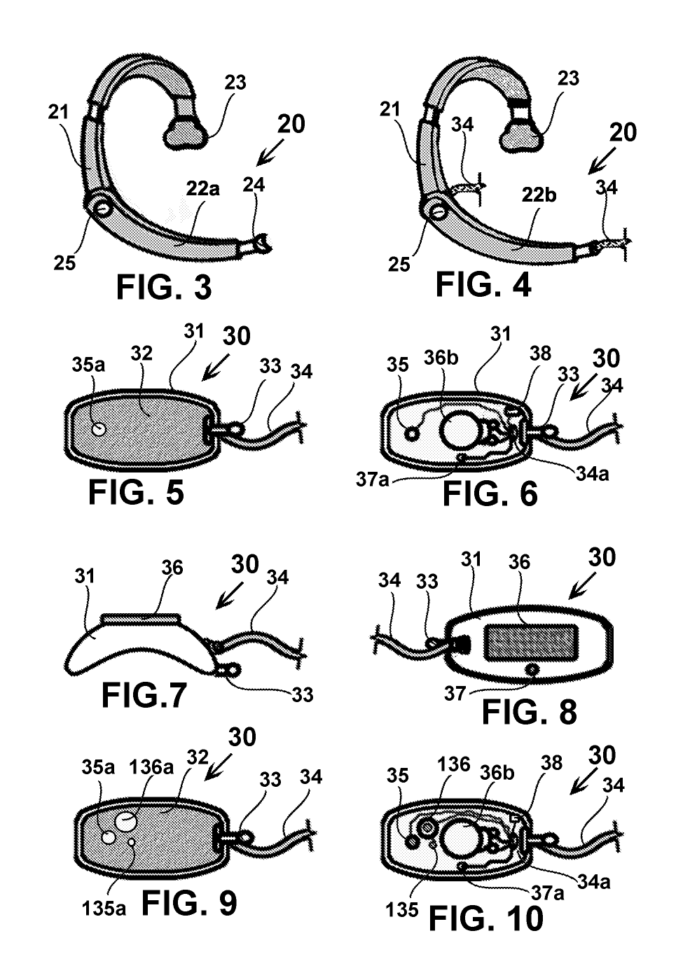

FIG. 3 shows a headband assembly 20 comprising: an adjustable over-the-head arcuate component 21, an extensible rotating boom component 22a having one end attached to the arcuate unit 21 by a hinge mechanism 25 and the other end having a ball-and-socket mechanism 24 that connects to a mouthpiece assembly 30, and a temple pad portion 23 positioned at the other end of arcuate unit 21 to secure the assembly firmly onto a user's head. Further, the ball-and-socket unit 24 can have detent functionality to keep the mouthpiece 30 in place during operation and non-operation. In another embodiment of the invention 10, the other end of arcuate unit 21 can be terminated with a mechanism to accomodate a second earcup component 44 instead of a temple portion 23.

FIG. 4 shows an embodiment of headband assembly 20 that can comprise an adjustable arcuate unit 21, a flexible rotating boom unit 22b having one end attached to the arcuate unit 21 by a hinge mechanism 25 and the other end attached to the mouthpiece 30, and a temple pad part 23. Boom 22b is generally having a flexible and supple rubber material, and hollow to allow the wiring 34 to pass through thereby eliminating a dangling cord 34, making the device 10 less cumbersome. A similar structure can be seen in a prior art device such as the Motorola X205 gaming headset.

FIGS. 5-8 illustrate different views of the mouthpiece assembly 30 comprising: a generally concave-shaped housing 31 conformed to the contour of a user's mouth area; a sound blocking protective cover or liner 32; a pivot member 33 to allow the mouthpiece 30 to swivel sideways; a cable or wiring harness 34; a suitable wiring hole 34a for cable 34; an internal microphone 35 to capture the speech of a user 100; a suitable acoustic opening 35a to allow optimal sound to reach microphone 35; an external loudspeaker 36 optimally positioned to output an amplified translated speech for a foreigner to hear; an external microphone 37 optimally positioned to capture the speech of a foreigner 200 that can be translated to a user's language; and a sensor or proximity switch 38 that detects the state of the mouthpiece 30, whether it is covering a user's mouth or not. The pivot member 33 is part of the ball-and-socket mechanism 24 located on one end of the boom 22a.

The internal microphone 35 can also be used to control the output volume of loudspeaker 37 by means of voice-enabled command software. An inline mute and volume control may also be utilized to control the intensities of the translated sounds. A manual potentiometer can also be incorporated on the device 10 to attain a suitable volume of the speech output. Further, a video camera may also be located on the exterior of assembly 30 or somewhere on the headband assembly 20 to capture a foreigner's gestures.

FIGS. 9 and 10 show another embodiment of the invention 10 whereby the mouthpiece assembly 30 is seen having additional components that provide active noise canceling capababilities for the invention 10 comprising of a microphone 136, a speaker 137, and noise cancellation electronics (optionally integrated in the language translation assembly 40). Microphone 136 captures the user's speech to generate the anti-noise sound wave to be fed to speaker 137 which would cause the interference to reduce the unwanted vocal sounds of the user. Alternatively, internal microphone 36 can have a dual use and may be used instead microphone 136 to also generate the anti-noise signal. Suitable openings 136a and 137a are provided for the sounds to pass through the sound blocking cover 38.

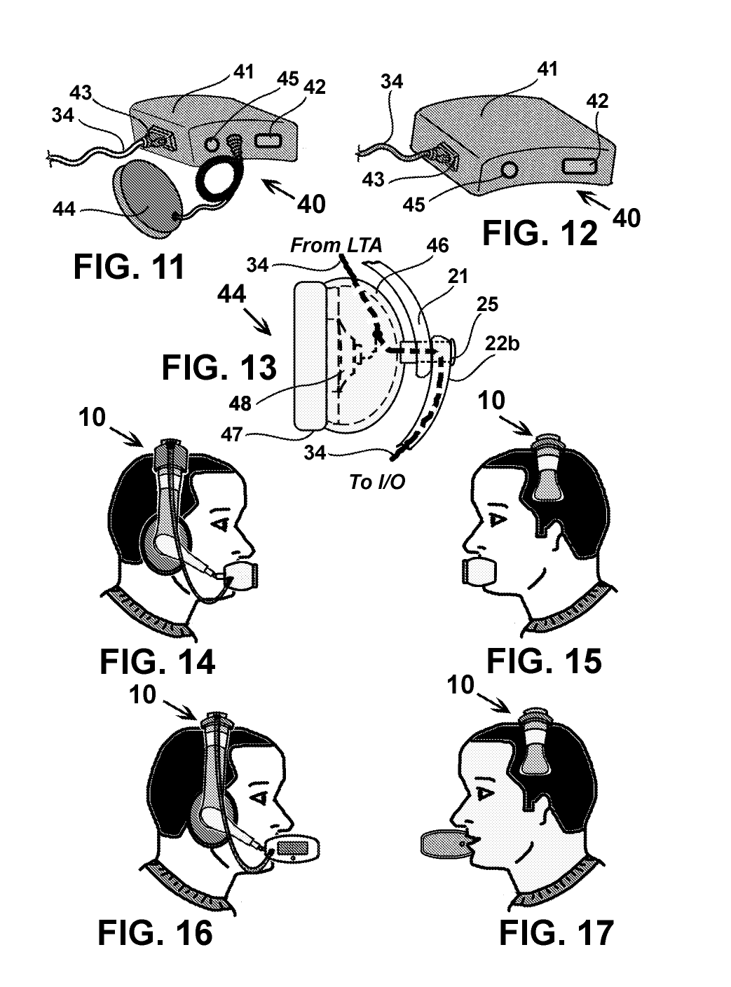

FIGS. 11 and 12 illustrate a language translation assembly 40, LTA for short, comprising: a personal translator 40a that translates one or more languages into one or more targeted languages locally or a personal transceiver 40b that receives translated speech from a remote facility; a translator housing 41; a volume control switch 42; a cable connector, a USB adapter, a quick-disconnect adapter, or a quick-connect adaptor 43 to facilitate connectivity for the input and output devices such as a microphone or a loudspeaker located on the mouthpiece 30 through the cable 34; an earphone 44 which allows a user to hear the translated language; and a switch or multi-key 45 to activate or deactivate the translation assembly 40. The translation assembly 40 shown in FIG. 11 is for a hinge mechanism embodiment whereby a separate wiring connects the speaker 48 of the earpiece or earcup 44 to the personal translator 40a. FIG. 12 shows an embodiment of a flexible boom configuration whereby the connectivity for the speaker 48 to the translation assembly 40 is undertaken by cable 43 which comprise at least three pairs of wires, one of the pairs allocated for the speaker 48.

A personal translator 40a, which is one embodiment of a translation assembly 40, generally comprises a standalone portable computer or one of those new PCs called Netbooks but without a display screen. A preferred configuration could be a unit comprising a microprocessor, RAM for internal memory, SSD instead of a hard drive, I/O or audio interfaces, amplifier, battery for a power source, ROM firmware, and translation software.

A personal transceiver 40b, which is another embodiment of a translation assembly 40, generally comprises an integrated transceiver system. It sends speech signals to a remote language translation facility 80 that translates one or more languages into one or more targeted languages, either by human interpreters or by automated machine translators, and then receives the translated speech whereby said speech is conditioned to suitable signal levels for intelligibility. A transceiver used for processing a foreigner's speech may be a separate component or module utilizing a different frequency than the one used for the user but should still be enclosed in the same translator housing 41. It is understood that the translator 40 is an assembly therefore can consist of various modules or components. The charge capacity and size of battery 42 is dependent upon the user's preference. Further, the transceiver function of the device 10 allows a human translator to be situated thousands of miles away.

FIG. 13 is an exploded view of an earcup component 44 of a flexible hollow boom embodiment showing the general routing of the cable 34 starting from the language translation assembly (LTA) then through the earcup housing 46 wherein some wires connect to the speaker 48. Wiring 34 is further routed through the hollow pivot component 25, then through the hollow boom 22b, and finally terminating at the input/output (I/O) components on the mouthpiece 30. Earmuff or cushion 47 provides the user comfort while wearing the device 10.

FIGS. 14 and 15 show pictorial side views of how invention 10, shown with the mouthpiece 30 covering a user's mouth, would look like when ‘used’ for translating.

FIGS. 16 and 17 show pictorial side views of how invention 10, shown with the mouthpiece 30 uncovering a user's mouth, would look like when ‘not used’ for translating. In this circumstance, the device 10 is deactivated or powered down and the user is able to converse in his native language.

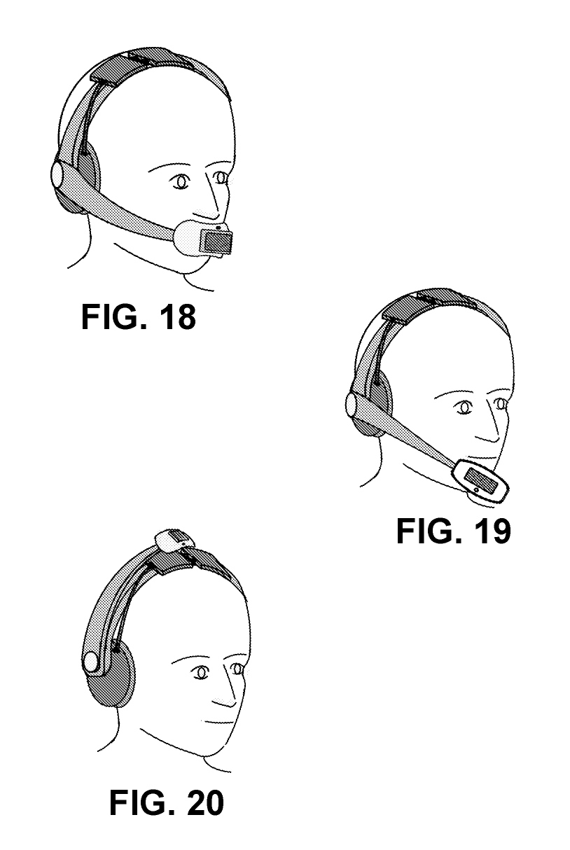

FIGS. 18, 19, and 20 are views of a flexible boom embodiment of invention 10. As seen on the first figure, the device 10 is being used for translating, on the second figure being on standby, and on the third being on a standby/storage arrangement. To expound on explanation of the first figure, it shows the device 10 being used for language translation whereby the mouthpiece 30 is swiveled sideways and seen covering the mouth area of a user 100 thereby preventing some of the unwanted untranslated speech from being heard by a foreigner. In this circumstance, the LTA 40 is activated or powered up, causing the user's speech to be translated to a foreigner's language whereby the loudspeaker 36, seen on the rear of mouthpiece 30 (viewed from a user's perspective), outputs the translated speech for a foreigner 200 to hear. The microphone 37 seen on the front of mouthpiece 30 captures the speech of a foreigner 200 whereby it is translated and the translated signal received and then fed to earpiece 44 for a user 100 to hear.

Seen in FIG. 19, the mouthpiece 30 is swiveled outward uncovering the user's mouth allowing his/her native or untranslated speech to be heard. In this circumstance, the LTA 40 is either deactivated or on standby. When it is in a standby mode, the device 10 may shut down completely after a predetermined number of seconds in order to conserve power. FIG. 20 is another example of the device 10 being in a deactivated mode whereby the boom is swiveled upwards to lessen or reduce the cumbersomeness of wearing the device 10. Another way of reducing such awkwardness is to make the device 10 more foldable.

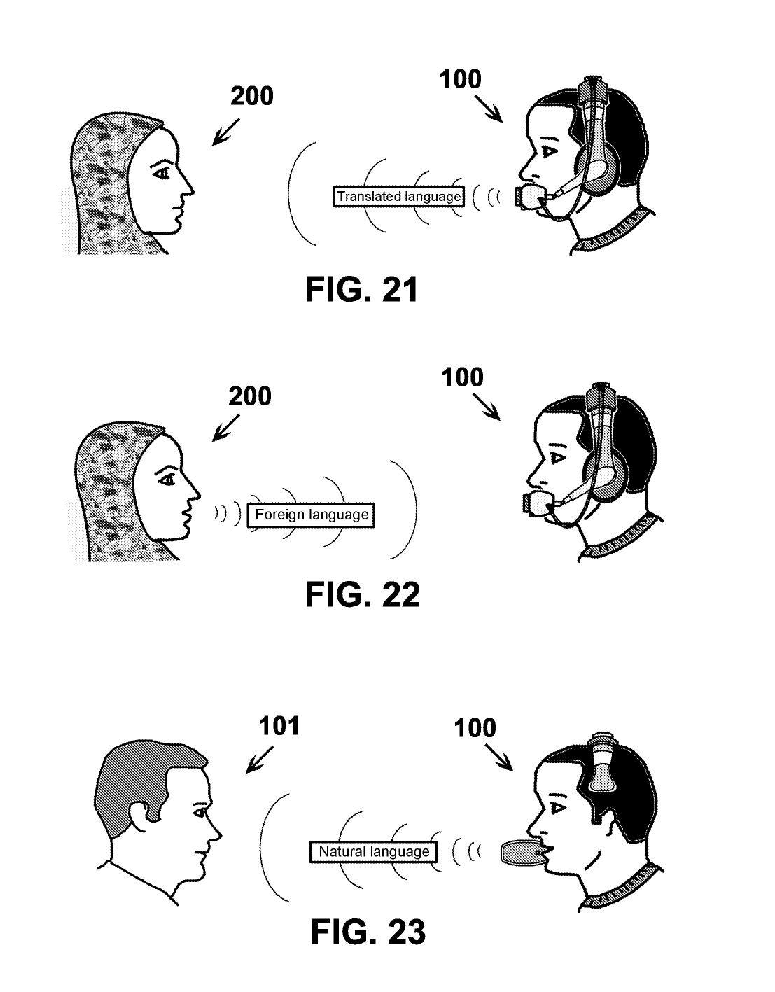

FIGS. 21-23 are pictorial representations illustrating in more detail the explanations provided by the preceding two paragraphs between a user 100, a foreigner 200, and a native speaker 101. The first figure shows the user 100 translating to a foreigner 200. The second shows a foreigner 200 speaking to the user 100 and the third figure shows a user 100 speaking to someone 101 who understands his untranslated language.

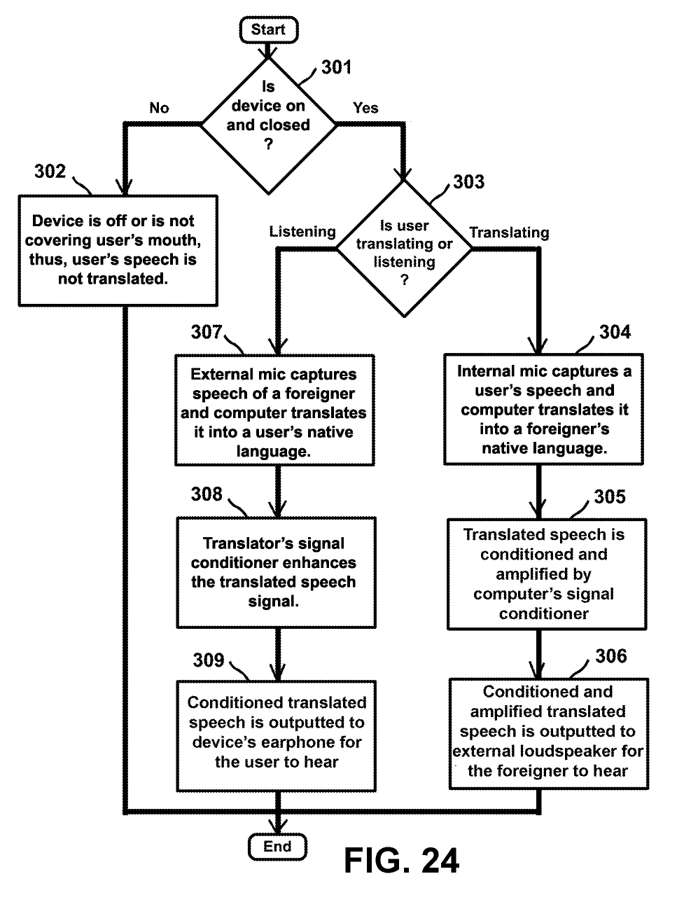

FIG. 24 shows a flowchart diagram summarizing a process for a personal translator 40a embodiment of the invention whereby a speech-to-speech translation process starts by checking to see if user 100 is using the invention 10, such as when the mouthpiece 30 is swiveled inward covering a user's mouth area or closed (step 301). If the device 10 is not being used then the mouthpiece 30 is generally in an open or swiveled outward arrangement and is either on a standby mode or completely powered down (step 302). If invention 10 is in a standby mode, then as soon as the mouthpiece 30 is closed (covering user's mouth), the internal microphone 35 will receive and process the speech of the user 100 for translation by the personal translator 40a. Further, when said device 10 is in-use, a translating mode (the speech of user 100 is being translated) and a listening mode (the speech of foreigner 200 is being translated) can happen simultaneously (step 303) since both internal 35 and external 37 microphones are active at this juncture. It is preferred however that the translation and listening processes do not happen simultaneously in order to achieve an effective dialogue between the user 100 and the foreigner 200. This method can be achieved by using different frequencies for the two translation signals.

In the translating mode, the user 100 speaks into the microphone 35 located inside the mouthpiece 30 whereupon his speech is translated by the translator 40a (step 304). A short while thereafter, the translator 40a produces and amplifies the translated speech (step 305).

The final step of the translation mode further includes the process whereby the amplified translated speech signal gets fed to an external loudspeaker 36 positioned on the exterior of the mouthpiece 30 producing an audible output for a foreigner 200 to hear the translation (step 306).

In the listening mode, the foreigner 200 speaks in the general direction of the user 100 or device 10, specifically towards microphone 37 located on the exterior of mouthpiece 30, whereby the speech of the foreigner 200 is captured and thereupon gets translated by the language translator 40a (step 307). A short while thereafter, although at times almost instantaneously, translator 40a produces the translated speech and conditions said translation signal (step 308).

As a final step in the listening mode, the conditioned translated speech signal is outputted to an earpiece 44 thereby allowing the user 100 to hear the translated speech of the foreigner 200 (step 309).

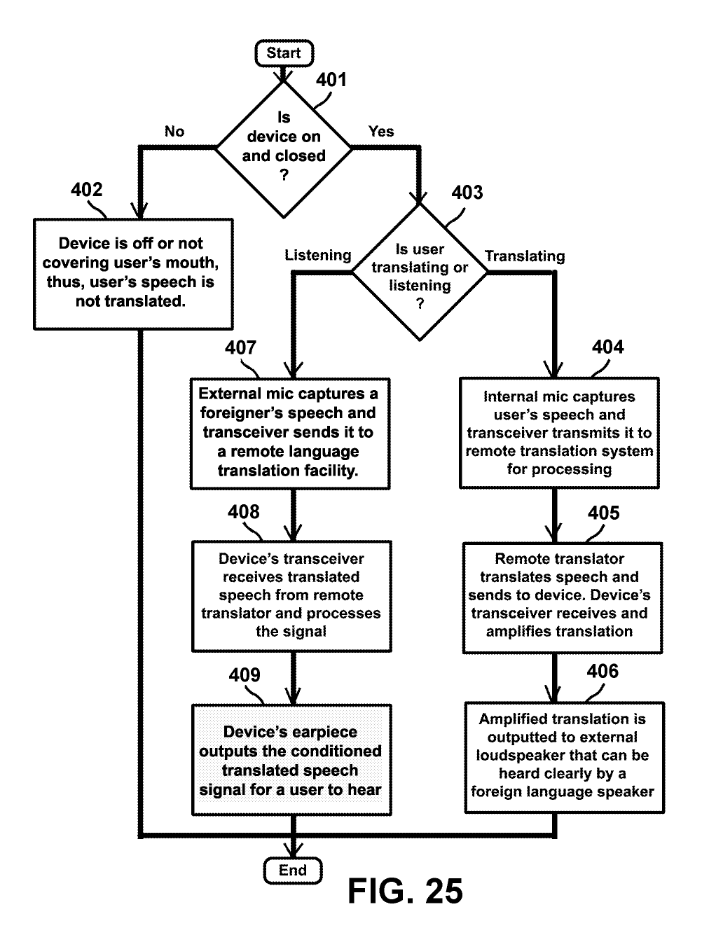

FIG. 25 shows a flowchart diagram summarizing a personal transceiver 40b embodiment of the invention 10 whereby a process for speech-to-speech language translation starts by checking to see if user 100 is using the invention 10, such as when the mouthpiece 30 is swiveled inward covering a user's mouth area or closed (step 401). If the device 10 is not being used then the mouthpiece 30 is generally in an open or swiveled outward arrangement and is either on a standby mode or completely powered down (step 402). If invention 10 is in a standby mode, then as soon as the mouthpiece 30 is closed (covering user's mouth), the internal microphone 36 will receive and process the speech of the user 100 for translation. Further, when said device 10 is in-use, a translating mode (the speech of user 100 is being translated) and a listening mode (the speech of foreigner 200 is being translated) can happen simultaneously (step 403) since both internal 35 and external 37 microphones are active at this juncture. It is preferred however that the translation and listening modes do not happen simultaneously in order to achieve an effective dialogue between the user 100 and the foreigner 200.

In the translating mode, the user 100 speaks into the microphone 35 located inside the mouthpiece 30 whereupon his speech is transmitted by the transceiver 40b to a remote language translation system 80 either via base station 70 directly or by way of a wireless headset 50 or by way of a mobile phone 60 or a USB dongle 70 or another RF transceiver 70 or any combination thereof (step 404). A short while thereafter, the language translation system 80 produces the translated speech and sends it to the device 10 whereby the transceiver 40b receives and amplifies said translation (step 405).

The final step includes the process whereby the amplified translated speech signal gets fed to an external loudspeaker 36 positioned on the exterior of the mouthpiece 30 producing an audible output for a foreigner 200 to hear the translation (step 406).

In the listening mode, the foreigner 200 speaks in the general direction of the device 10, specifically towards microphone 37 located on the exterior of mouthpiece 30, whereby the speech of the foreigner 200 is captured and thereupon gets transmitted by the transceiver 40b to a remote language translation system 80 by way of a wireless base station 70 or a wireless headset 50 or a mobile phone 60 or a combination thereof (step 407). A short while thereafter, although at times almost instantaneously, the language translation system 80 produces the translated speech and sends it to the device 10 whereby the transceiver 40b receives and processes said translation signal (step 408).

As a final step in the listening mode, the processed translated speech signal is outputted to an earphone 44 connected to a transceiver 40b thereby allowing the user 100 to hear the translated speech of the foreigner 200 (step 409).

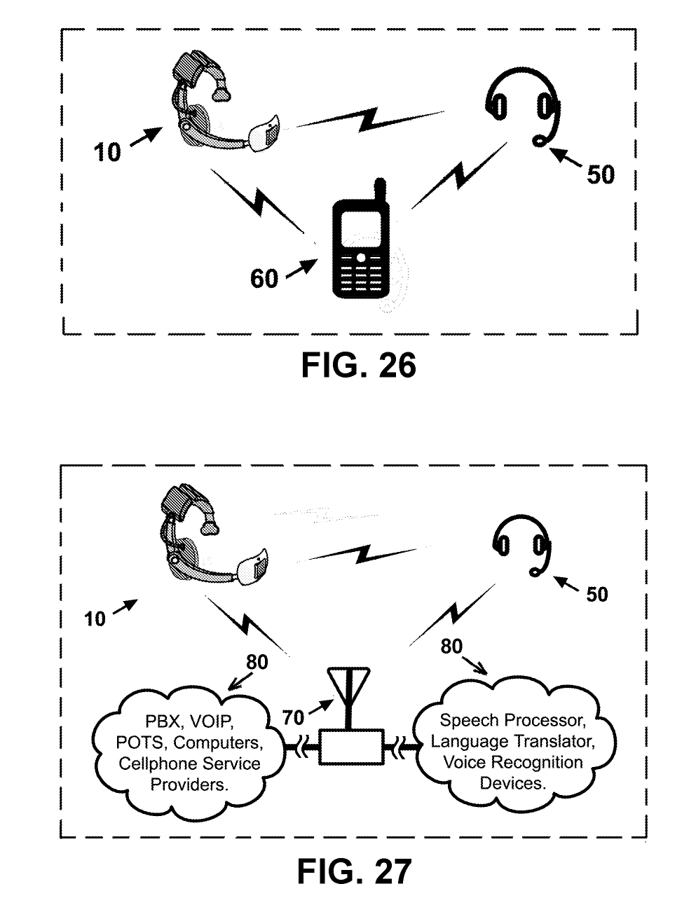

FIG. 26 shows a diagram of an embodiment of the invention 10 whereby the integrated transceiver 40b is having a multiplexed communication with either a mobile phone 60 or with a wireless headset 50 or with a cordless earphone 49 or a combination thereof. The device 10 also sends and/or receives other wireless signals such as control, monitoring, and/or management signals from a mobile phone 60 or a headset 50 or a cordless earphone 49 or a combination thereof. The mobile phone 60 generally connects to a cellphone service provider such as Verizon or AT&T which can provide translation services, and other vendors such as Interpreters Unlimited which provide telephone interpretation services.

FIG. 27 shows a diagram of the invention 10 telecommunicating with a wireless headset 50 or a wireless base station unit 70 or a RF transceiver station 70 that connects to a system 80 that further connects to subsystems such as a PC, a computer file server, a video processing system, a voice recognition system, a cellphone service provider, an automatic language translation system, a human interpreter, a telephone interpreter service, a machine translator, TELCO, POTS, a transcription machine, other voice input processors and/or a combination thereof. The device 10 can also receive wireless signals such as voice commands, test signals, control signals, video signals, monitoring and management signals from other systems 80 through base station or transceiver 70 or a headset 50 or a combination thereof.

I claim:

1. A headset language translation device comprising a resilient arcuate headband assembly having a top portion comprising a transceiver and a bottom portion comprising a hinge that connects a hollow face piece further comprising:
a primary microphone to capture a user's speech;
and a loudspeaker to deliver a translated speech to a person other than the user of said device.

2. The headset language translation device according to claim 1 wherein said hollow face piece further comprises a supple material conforming to the brims of the open end units associated with a user's mouth area.

3. The headset language translation device according to claim 1 wherein said hollow face piece further comprises a sensor or switch, or a combination thereof, associated with said transceiver.

4. The headset language translation device according to claim 1 wherein said hollow face piece further comprises a secondary microphone to capture a speech of a person other than the user of said device.

5. The headset language translation device according to claim 1 wherein said hollow face piece further comprises an earphone to deliver signals to a user of said device.

6. A headset language translation device comprising a resilient arcuate headband assembly having a top portion comprising a transceiver and a bottom portion comprising a hinge that connects a hollow face piece further comprising:
a noise reducing component;
a primary microphone to capture a user's speech;
and a loudspeaker to deliver a translated speech to a person other than the user of said device.

7. The headset language translation device according to claim 6 wherein said hollow face piece further comprises a supple material conforming to the brims of the open end units associated with a user's mouth area.

8. The headset language translation device according to claim 6 wherein said hollow face piece further comprises a sensor or switch, or a combination thereof, associated with said transceiver.

9. The headset language translation device according to claim 6 wherein said hollow face piece further comprises a secondary microphone to capture a speech of a person other than the user of said device.

10. The headset language translation device according to claim 6 wherein said hollow face piece further comprises an earphone to deliver signals to a user of said device.

11. The headset language translation device to according to claim 6 wherein said hollow face piece having a means for varying the input or output signals to or from said transceiver.

12. The headset language translation device according to claim 6 wherein said noise reducing component is removable.

13. A headset language translation device comprising a resilient arcuate headband assembly having a top portion comprising a transceiver and a bottom portion comprising a hinge that connects a hollow face piece further comprising:
a noise reducing component;
a primary microphone to capture a user's speech;
a secondary microphone to capture the speech of a person other than the user of said device;
and a loudspeaker to deliver a translated speech to a person other than the user of said device.

14. The headset language translation device according to claim 13 wherein said hollow face piece further comprises a supple material conforming to the brims of the open end units associated with a user's mouth area.

15. The headset language translation device according to claim 13 wherein said hollow face piece further comprises a sensor or switch, or a combination thereof, associated with said transceiver.

16. The headset language translation device according to claim 13 wherein said hollow face piece further comprises an earphone to deliver audio signals to a user of said device.

17. The headset language translation device to according to claim 13 wherein said hollow face piece having a means for varying the input or output signals to or from said transceiver.

18. The headset language translation device according to claim 13 wherein said hollow face piece further comprises a formable interior housing that reduces noise.

19. The headset language translation device according to claim 13 wherein said noise reducing component is removable.
